(19) United States
(12) Patent Application Publication
(10) Pub. No.: US 2006/0108281 A1
(43) Pub. Date: May 25, 2006

(54) Auxiliary scraper arrangement

(76) Inventor: Pekka Tuomikoski, Puuluntie (FI)

Correspondence Address: Woodling Krost & Rust, 9213 Chillicothe Road, Kirtland, OH, 44094, US

(21) Appl. No.: 10/537,147

(22) PCT Filed: Dec. 15, 2003
(86) PCT No.: PCT/FI03/00953

§ 371 Date: Oct. 12, 2005

(30) Foreign Application Priority Data
Jan. 24, 2003 (FI) 20030110

(51) Int. Cl. B01D 17/00

(52) U.S. Cl. 210/526

(57) ABSTRACT

The invention relates to an auxiliary scraper arrangement, intended particularly for enhancing a scraping process performed by a scraper bar assembly in a liquid tank, such as a settling tank or the like. The auxiliary scraper arrangement (X) comprises one or more extensions (X1), driven in response to actuators (X2) to two or more working positions (I, II) different from each other relative to the scraping bar (1) during its movement in the liquid tank. In the first working position, the extension (X1) is intended for scraping the supernatant sludge present on the wall of the tank, while the scraper bar (1) is at the liquid surface. In the second position, the extension is intended for scraping the sludge present on an inclined surface (VP) at the bottom of the tank while the scraper is upside down at the bottom of the tank. The actuators (X2) are provided with a gravitationally powered mechanism, including the extension (X1) which is connected at an articulation (N) pivotally (w) to the scraper bar (1), the extension (X1) having a counterweight (z) coupled therewith on the opposite side of the articulation (N) by way of a lover arm (y).

The invention relates to an auxiliary scraper arrangement, intended particularly for enhancing a scraping process performed by a scraper bar assembly in a liquid tank, such as in a settling tank or the like, reinforced at least in its bottom portion, such as provided with wall structures having a cross-section which includes one or more sections tapering upwards in a vertical direction, the object in this context being firstly the elimination of supernatant matter in the liquid tank by way of a first discharge arrangement, such as a supernatant sludge launder or the like, and secondly the elimination of bottom matter in the liquid tank by way of a second discharge arrangement, such as a bottom sludge pocket or the like. The scraper bar assembly comprises one or more scraper bars in succession in a longitudinal direction of the liquid tank, which are adapted to be operated by means of drive elements, such as one or more transmission chains or the like driven through the intermediary of a drive wheel and idle wheel assembly or in a like fashion, the scraper bar being engaged in connection therewith.

In applications as described above, it is conventional to arrange scraper bars to be driven by chains laid along the sides of a tank in such a way that, firstly with regard to the bottom, a material lying on the bottom is scraped thereby into a sludge pocket, and secondly a supernatant material is delivered thereby e.g. into a cross-tank extending collecting launder. In this respect, the scraper bars are designed traditionally as columns, fastenable by a screw connection to chains driving the same and manufactured e.g. in fiberglass. A particular drawback with totally single-piece scraper bars is the inconvenience regarding the installation thereof, which requires extremely precise and careful installation procedures in order to have the anticipated perforations of scraper bars exactly at correct spots. In practice, this causes often problems, e.g. as a result of irregularities of the bottom of a settling tank and the like reasons, which is why the perforating process generally cannot be performed until in situ during installation.

International publication WO 98/09892 discloses technical improvements relating to the above-discussed subject matter, in which case the scraper bar assembly makes use of scraper bars, comprising bar members dismountably engageable with each other. Thus, each scraper bar comprises preferably two first bar members engageable with drive chains present on the opposite walls of a liquid tank and at least one second bar member engaged therebetween e.g. on a quick coupling principle. This type of solution provides a multitude of various advantages over traditional solutions, especially with regard to installation, service, and maintenance procedures. Consequently, it is possible to minimize costs incurred particularly by the maintenance of a scraper bar assembly simply by replacing the first bar members included in scraper bars. On the other hand, such a solution enables the use of materials as high quality as possible in manufacturing middle members for scraper bars, which function as actual scrapers, because in practical conditions such members do not often sustain damage in normal operation.

One practical problem, yet without successful solutions as of today, relates particularly to the use of liquid tank constructions employed in regions likely to experience earth quakes. In such conditions, the bottom part of a liquid tank must be reinforced by using for example wall structures tapering cross-sectionally upwards in vertical direction in one or more sections. Hence, the vertical wall structures of a liquid tank are generally designed e.g. in such a way that, first of all, each intermediate wall is connected to the liquid tank's bottom or floor slab by way of an inclined surface. On the other hand, each intermediate wall can be additionally or instead designed to have an upward tapering cross-section. Such structures enable sufficient bracing for a liquid tank even in demanding conditions. A result of this is, however, that the liquid tank will have a top surface area which is substantially larger than its bottom surface area.

A practical problem in this respect, especially when using currently available scraper bar assemblies, is that, regarding the bottom of a liquid tank, traditional scraper bars are only effective in scraping a totally flat bottom surface of the liquid tank, but not an inclined surface bridging the bottom and the intermediate wall. A further consequence is that, at the surface level of a liquid tank, the scraper bars continuously fail to scrape a matter present along the liquid tank walls over a fairly extensive area, which leads to all sorts of practical problems as it allows supernatant scum or sludge to build up on the walls, resulting in caking and the like.

It is an object of an auxiliary scraper arrangement of the invention to reduce e.g. the above-discussed problems and thereby to raise substantially the existing state of the art. In order to accomplish this object, an auxiliary scraper arrangement of the invention is principally characterized in that actuators for driving an extension from one working position to another are provided with a self-powered mechanism, whereby on the one hand the extension is connectable at an articulation point (N) pivotally to the scraper bar, and on the other hand the extension has a counterweight coupled therewith on the opposite side of the articulation point by way of a lever arm for operating the extension gravitationally on a leverage principle from one working position to another, firstly for scraping the supernatant sludge present on the wall of the liquid tank while the scraper bar is in a basic position on the surface of the liquid tank, and secondly for scraping the sludge present on an inclined surface at the bottom of the liquid tank while the scraper bar is upside down on the bottom of the liquid tank.

The most important benefits gained by an auxiliary scraper arrangement of the invention include the simplicity and operating reliability of its construction, operation, and working principle, by virtue of which it is possible to significantly reduce its service and maintenance work. Thus, the auxiliary scraper arrangement enables the use of completely self-effected procedures to ensure the optimal operation of a settling tank, such that supernatant scum is not able to build up, especially along the tank's side walls. This is further feasible, preferably e.g. in such a way that the inventive auxiliary scraper arrangement is only mounted e.g. on two scraper bars, the disposition of which is such that, as one is presently at the liquid surface, the other is conducting a bottom scraping process. Therefore, by means of the inventive auxiliary scraper arrangement, it is possible with extremely low costs to enhance remarkably a functionality of the discussed processes while reducing significantly the operating costs thereof as a direct consequence of lessened requirement for process monitoring. Optimal operation for the inventive auxiliary scraper arrangement is ensured in its simplest form by using a self-powered mechanism as actuators driving an extension from one working position to another, which mechanism, in response to gravity, by using e.g. a counterweight, applies a leverage principle for driving the extension engaged with a presently deployed scraper to its presently required working position. Another benefit gained by an auxiliary scraper arrangement of the invention is that it also enables a further enhancement of the scraping process in a liquid tank of perfectly rectangular cross-section when it is desirable to keep the liquid tank's side walls clean of e.g. micro-organisms and plants, which can be further enhanced by providing an extension included in the auxiliary scraper arrangement additionally with e.g. bristles or the like.

The dependent claims directed to the invention disclose a few preferred embodiments for an auxiliary scraper arrangement of the invention.

The invention will be described in detail in the following specification while reference is made to the accompanying drawings, in which

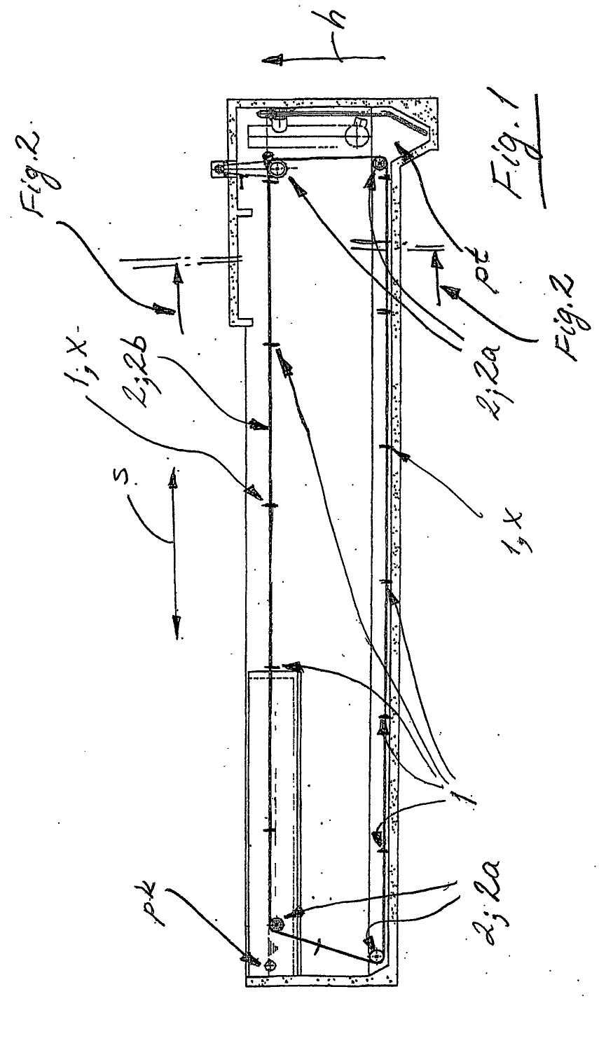

FIG. 1a shows in a side view one typical application site for an auxiliary scraper arrangement of the invention,

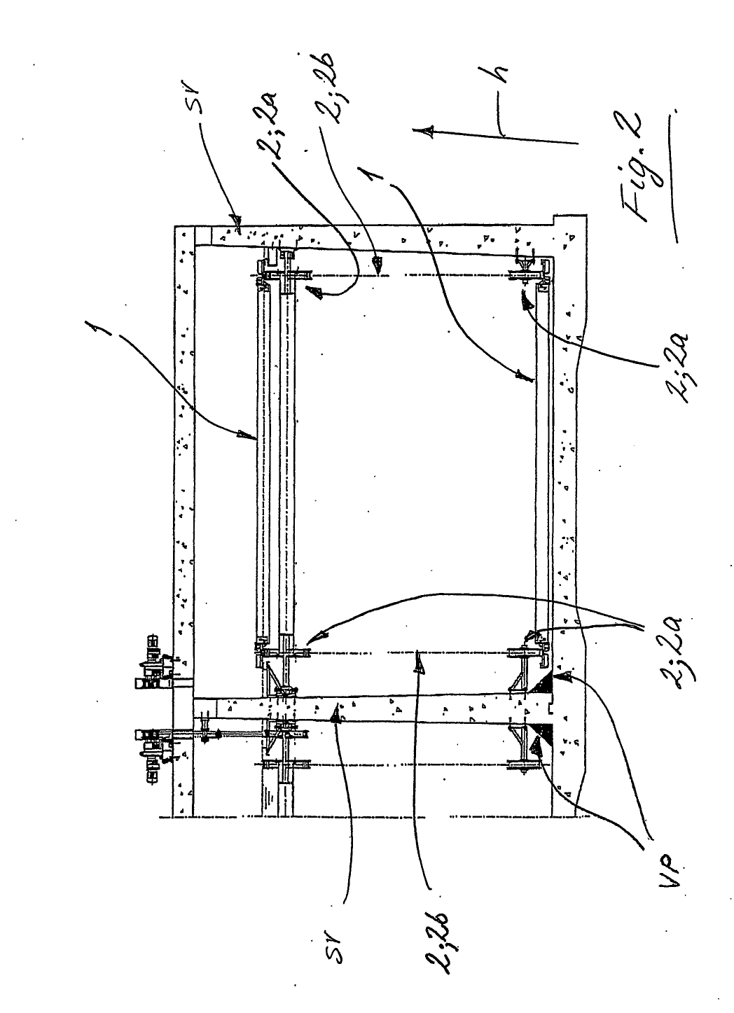

FIG. 2 shows a cross-section at FIG. 2—FIG. 2 in FIG. 1,

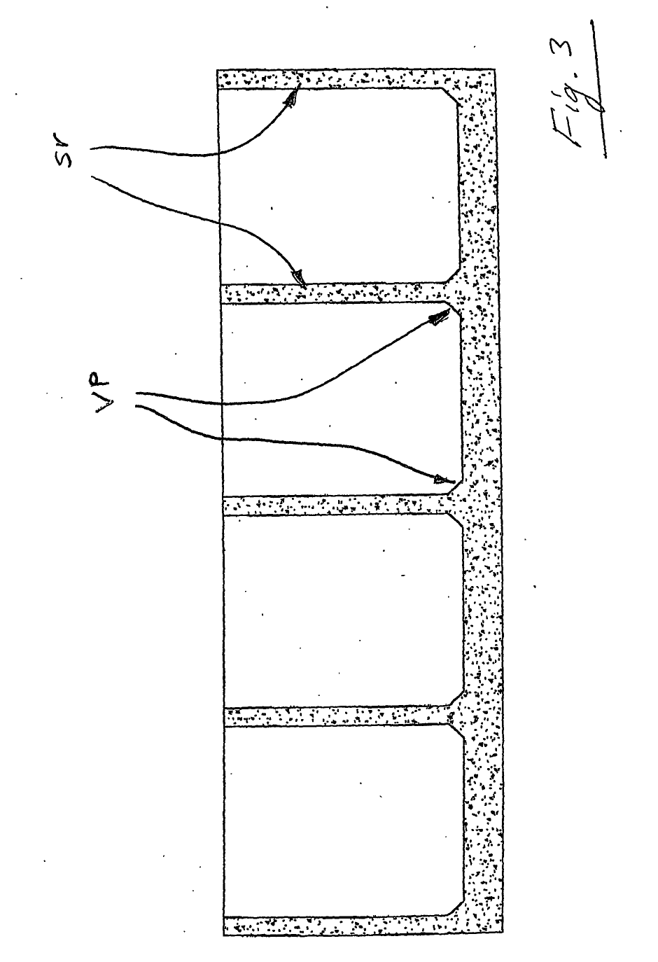

FIG. 3 shows further one typical application site for an auxiliary scraper arrangement of the invention in cross-section,

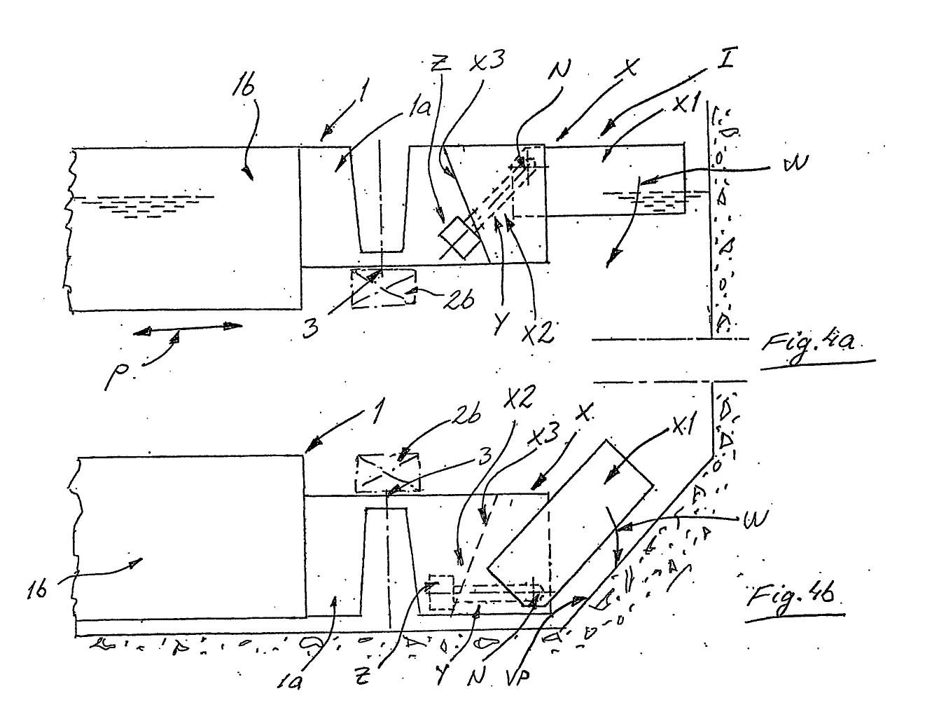

FIGS. 4a and 4b show one preferred operating principle for an auxiliary scraper arrangement of the invention in various working positions of an extension included therein,

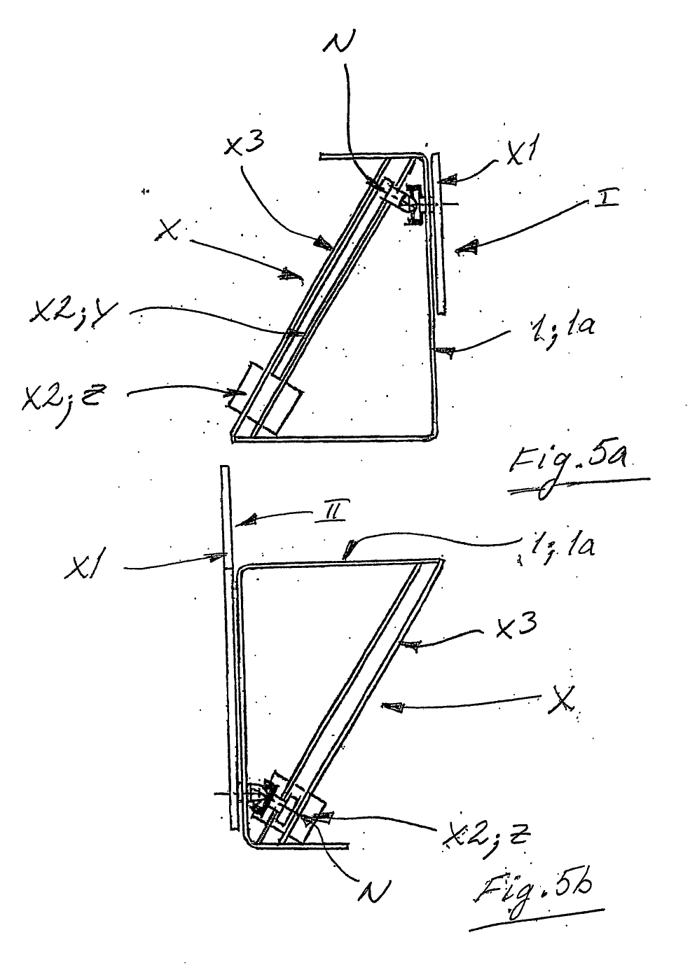

FIGS. 5a and 5b show further a more detailed illustration in an end view for a scraper bar, regarding one preferred embodiment for an auxiliary scraper arrangement of the invention in a basic position (FIG. 4a) of the scraper bar and in its upside down position (FIG. 4b), and

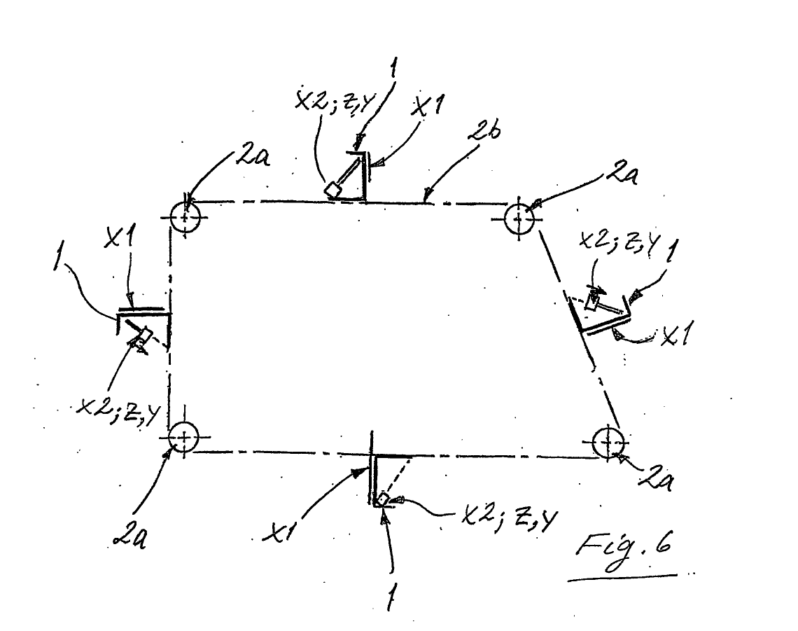

FIG. 6 shows further an operating principle for a type of solution shown in FIGS. 5a and 5b, in an illustrative side view while a scraper bar is in motion in a liquid tank.

The invention relates to an auxiliary scraper arrangement, intended particularly for enhancing a scraping process performed by a scraper bar assembly in a liquid tank, such as in a settling tank or the like, reinforced at least in its bottom portion, such as provided with wall structures sr having a cross-section which includes, as shown in FIG. 3, one or, as shown in FIG. 2, two sections tapering upwards in a vertical direction h, the object in this context being firstly the elimination of supernatant matter in the liquid tank by way of a first discharge arrangement pk, such as a supernatant sludge launder or the like, and secondly the elimination of bottom matter in the liquid tank by way of a second discharge arrangement pk, such as a bottom sludge pocket or the like. The scraper bar assembly comprises, as shown particularly in FIG. 1, one or more scraper bars 1 in succession in a longitudinal directions of the liquid tank, which are adapted to be operated by means of drive elements 2, such as one or more transmission chains 2b or the like driven through the intermediary of a drive wheel and idle wheel assembly 2a or in a like fashion, each scraper bar 1 being engaged in connection therewith. An auxiliary scraper arrangement X comprises one or more extensions X1, provided on one or more scraper bars 1 and adapted to enhance a scraping process by being driven in response to actuators X2, e.g. on a principle shown in FIGS. 4a/4b and 6, to two or more working positions I, II essentially different from each other relative to the scraper bar 1 during its movement in the liquid tank.

The inventive auxiliary scraper arrangement comprises, as shown e.g. in FIGS. 4a and 4b, a substantially elongated extension X1 which is adapted, as shown in FIG. 4a, in its first working position I being in a cross-sectional sense substantially co-directional with the scraper bar 1, with the scraper bar 1 maneuvering at the surface level of a liquid tank, to scrape supernatant sludge present on the wall of the liquid tank.

Furthermore the auxiliary scraper arrangement comprises a substantially elongated extension X1 which is adapted, as shown specifically in FIG. 4b, in its second working position II with the scraper bar 1 maneuvering along the bottom of a liquid tank, to scrape, in a position inclined relative to the scraper bar 1, the liquid tank's floor along an inclined surface VP of the wall structure's lower portion.

The actuators X2 for driving the extension X1 from one working position to another I, II are provided with a self-powered mechanism. As shown e.g. in FIGS. 4a/4b and 5a/5b, such a self-powered mechanism X2 is provided with the extension X1, which is connected at an articulation N pivotally w to the scraper bar 1, the extension X1, particularly in reference to what is shown in FIGS. 4a/4b, having a counterweight z coupled therewith on the opposite side of the articulation N by way of a lever arm y for operating the extension X1 gravitationally on a leverage principle from one working position to another I, II, the scraper bar 1 being, as shown e.g. in FIGS. 4a or 5a, in a basic position on the surface of the liquid tank or, as shown e.g. in FIGS. 4b or 5b, upside down on the bottom of the liquid tank. FIG. 6 further illustrates in a side view the operating principle of the above type of extension X1 as the scraper bar 1 progresses along its path in a liquid tank.

In a preferred embodiment, as shown e.g. in FIGS. 5a and 5b, the extension X1 comprises a thin baffle, blade structure or the like manufactured in a plastic and/or metal material.

In an other preferred embodiment, the inventive auxiliary scraper arrangement is utilized in conjunction with a scraper bar assembly, the scraper bar 1 included therein being preferably assembled from bar members 1a, 1b engageable with each other e.g. in a dismountable manner, such as two first bar members 1a engageable in a dismountable manner, such as by means of a screw connection 3 or the like, with the drive elements 2, such as two parallel transmission chains 2b, and from at least one second bar member 1b coupled therebetween, which comprises an at least partially hollow box structure, such as a fiberglass column or the like, extending with a constant cross-section in a lengthwise direction p of the scraper bar 1. In this type of embodiment, the auxiliary scraper arrangement X in its simplest form, as shown in principle e.g. in FIG. 1, is provided on the distal end of either or both first bar members 1a of at least one liquid-surface working and one liquid-tank bottom working scraper bar 1.

In reference to the preferred embodiments shown especially in FIGS. 4a/4b and 5a/5b, the first bar member 1a is further provided with control elements X3, such as guides and/or guards or the like, for controlling and/or limiting specifically a movement of the counterweight z.

It is obvious that the invention is not limited to the embodiments described or specified above, but it can be modified quite extensively within the basic inventive concept according to varying contemporary requirements. Firstly, as already pointed out above, it is possible to apply the invention also in relation with tanks, which are completely rectilinear regarding the cross-section of side walls and/or rectangular regarding the junction of side walls, in which case the specific purpose can be to maintain a clean settling tank at the top surface water level, whereby, whenever the scraper is in operation at the liquid surface, the auxiliary scraper arrangement of the invention functions has its extension function as an actuator clearing the side walls of e.g. micro-organisms and vegetation or the like. In this type of solution, the extension is preferably provided, whenever necessary, with e.g. bristles and its attitude is adjusted, whenever the scraper is in operation in the bottom of a liquid tank, e.g. at a 90° angle relative to the scraper bar, whereby it shall not be directly involved in any way in the actual scraping process during the time it is on the bottom of the liquid tank.

It is naturally obvious that scrapers used in the scraper assembly can be totally single-piece units of an appropriate manufacturing material. In addition, it is of course possible to assemble the functional components for an auxiliary scraper arrangement of the invention not only from plastics and metal but also from a multitude of various materials, such as e.g. carbon fiber, composite materials, or else from ceramic materials. Moreover, most diversified profiles can be used as a chain profile. When using e.g. a type of chain referred to as a so-called bicycle type chain, it is necessary to employ an angle or the like fastened to the back of the chain, which is subjected to moments by the mere attachment of a scraper bar, and therefore, in this context, this is far from the best possible implementation regarding its efficiency and operating reliability.

1. An auxiliary scraper arrangement, intended for enhancing a scraping process performed by a scraper bar assembly in a liquid tank, such as in a settling tank or the like, reinforced at least in its bottom portion, such as provided with wall structures (sr) having a cross-section which includes one or more sections tapering upwards in a vertical direction (h), the object in this context being firstly the elimination of supernatant matter in the liquid tank by way of a first discharge arrangement (pk), such as a supernatant sludge launder or the like, and secondly the elimination of bottom matter in the liquid tank by way of a second discharge arrangement (pt), such as a bottom sludge pocket (pt) or the like, said scraper bar assembly comprising one or more scraper bars (1) in succession in a longitudinal direction (s) of the liquid tank, which are adapted to be operated by means of drive elements (2), such as one or more transmission chains (2b) or the like driven through the intermediary of a drive wheel and idle wheel assembly (2a) or in a like fashion, the scraper bar (1) being engaged in connection therewith, and said auxiliary scraper arrangement (X) comprising one or more substantially elongated extensions, providable on one or more scraper bars (1) and adapted to enhance a scraping process by being driven in response to actuators to two or more working positions essentially different from each other relative to the scraper bar (1) during its movement in the liquid tank, characterized in that actuators (X2) for driving an extension (X1) from one working position to another (I, II) are provided with a self-powered mechanism, whereby on the one hand the extension (X1) is connectable at an articulation point(N) pivotally (w) to the scraper bar (1), and on the other hand the extension (X1) has a counterweight (z) coupled therewith on the opposite side of the articulation point (N) by way of a lever arm (y) for operating the extension (X1) gravitationally on a leverage principle from one working position to another (I, II), firstly for scraping the supernatant sludge present on the wall of the liquid tank while the scraper bar (1) is in a basic position on the surface of the liquid tank, and secondly for scraping the sludge present on an inclined surface (VP) at the bottom of the liquid tank while the scraper bar (1) is upside down on the bottom of the liquid tank.

2. An auxiliary scraper arrangement as set forth in claim 1, characterized in that the extension (X1) comprises a thin baffle, blade structure or the like manufactured in a plastic and/or metal material.

3. An auxiliary scraper arrangement as set forth in claim 1, engageable with a scraper bar assembly, the scraper bar (1) included therein being assembled from bar members (1a, 1b) engageable with each other most preferably in a dismountable manner, such as two first bar members (1a) engageable in a dismountable manner, such as by means of a screw connection (3) or the like, with the drive elements (2), such as two parallel transmission chains (2b), and from at least one second bar member (1b) coupled therebetween, which comprises an at least partially hollow box structure, such as a fiberglass column or the like, extending with a constant cross-section in a lengthwise direction (p) of the scraper bar (1), characterized in that the auxiliary scraper arrangement (X) is providable on the distal end of either or both first bar members (1a) of at least one liquid-surface working and one liquid-tank bottom working scraper bar (1).

4. (canceled)

5. An auxiliary scraper arrangement as set forth in claim 2, engageable with a scraper bar assembly, the scraper bar (1) included therein being assembled from bar members (1a, 1b) engageable with each other most preferably in a dismountable manner, such as two first bar members (1a) engageable in a dismountable manner, such as by means of a screw connection (3) or the like, with the drive elements (2), such as two parallel transmission chains (2b), and from at least one second bar member (1b) coupled therebetween, which comprises an at least partially hollow box structure, such as a fiberglass column or the like, extending with a constant cross-section in a lengthwise direction (p) of the scraper bar (1), characterized in that the auxiliary scraper arrangement (X) is providable on the distal end of either or both first bar members (1a) of at least one liquid-surface working and one liquid-tank bottom working scraper bar (1).

6. An auxiliary scraper arrangement as set forth in claim 3, characterized in that the first bar member (1a) is provided with control elements (X3), such as guides and/or guards or the like, for controlling and/or limiting a movement of the counterweight (z).

7. An auxiliary scraper arrangement as set forth in claim 5, characterized in that the first bar member (1a) is provided with control elements (X3), such as guides and/or guards or the like, for controlling and/or limiting a movement of the counterweight (z).
